(19) United States
(12) Patent Application Publication
(10) Pub. No.: US 2020/0089806 A1
(43) Pub. Date: Mar. 19, 2020

(54) METHOD OF DETERMINING PROBABILITY OF ACCEPTING A PRODUCT/SERVICE

(71) Applicant: INTERNATIONAL BUSINESS MACHINES CORPORATION, Armonk, NY (US)

(72) Inventors: Aly MEGAHED, San Jose, CA (US); Hamid Reza Motahari Nezhad, San Jose, CA (US); Peifeng Yin, San Jose, CA (US)

(21) Appl. No.: 16/130,652

(22) Filed: Sep. 13, 2018

(51) Int. Cl. G06F 17/30; G06Q 30/02; G06Q 10/06; G06F 17/18; G06Q 50/00

(52) U.S. Cl. CPC G06F 17/30687; G06Q 30/0202; G06Q 50/01; G06F 17/18; G06Q 10/063

(57) ABSTRACT

A method of determining a probability of a procuring organization accepting a product/service offering of an offering organization may include using a processor to obtain a first collection of information items relating to the product/service offering and that may be generated internally of the offering organization. The method may include using the processor to obtain a second collection of information items relating to the first collection of information items and that may be generated externally of the offering organization. The method may further include using the processor to generate a respective relevance score for each second collection of information items relative to a corresponding first collection of information items and generate a respective sentiment score for each second collection of information items. The method may further include using the processor to generate the probability of accepting the product/service offering based upon the respective relevance scores and respective sentiment scores.

### BACKGROUND

The present invention relates to determining probabilities, and more specifically, to a method of determining a probability of acceptance of a product/service and related systems. Company-level or internal information may be used as a basis or indicator, for example, a probabilistic indicator, for determining whether a procuring organization will accept a product/service of an offering organization.

News, social media, analyst reports, competition news, and other externally available and public data may be particularly influential. For example, news, social media, analyst reports, competition news, and other externally available and public data may affect an outcome of any given in-progress engagement with a given client.

### SUMMARY

A method of determining a probability of a procuring organization accepting a product/service offering of an offering organization may include using a processor coupled to a memory to obtain a first collection of information items relating to the product/service offering from the offering organization to the procuring organization. The first collection of information items may be generated internally of the offering organization. The method may also include using the processor to obtain a second collection of information items relating to the first collection of information items. The second collection of information items may be generated externally of the offering organization. The method may further include using the processor to generate a respective relevance score for each of the second collection of information items relative to a corresponding one of the first collection of information items and generate a respective sentiment score for each of the second collection of information items. The processor may also be used to generate the probability of the procuring organization accepting the product/service offering based upon the respective relevance scores and respective sentiment scores.

The second collection of information items may include at least one of a news information item, a social media information item, and analyst report information item. The second collection of information items may include a second collection of unstructured information items, for example.

The first collection of information items may include at least one of a first collection of structured information items, a proposal term description, a document related to the product/service offering, structured metadata information, and a hierarchically configured first collection of information items, for example. Using the processor to obtain the first collection of information items may include using the processor to crawl at least one existing internally generated data repository to obtain the first collection of information items.

Using the processor to generate the respective relevance score may include using the processor to generate the respective relevance score based upon at least one of a cosine similarity and a mean absolute distance. Using the processor to obtain the second collection of information items may include obtaining the second collection of information items based upon a modeling signature for each of the second collection of information items, for example. The modeling signature may include at least one of a latent dirichlet allocation model and a Word2Vec model

Using the processor to generate the probability of the procuring organization accepting the product/service offering may include using the processor to generate the probability of the procuring organization accepting the product/service offering based upon a binary classification model, for example. Using the processor to generate the respective sentiment score for each of the second collection of information items may include using the processor to generate the respective sentiment score based upon a determined sentiment of each statement that includes a mention of the product/service.

Using the processor to generate the respective sentiment score may include using the processor to generate the respective sentiment score based upon a determined weight of each statement that includes the mention of the product/service. The determined weight may be determined based upon a depth of the mention of the product/service in a product/service hierarchy, for example.

A system aspect is directed to a system for determining a probability of a procuring organization accepting a product/service offering of an offering organization. The system may include a processor and a memory coupled thereto. The processor may be configured to obtain a first collection of information items relating to the product/service offering from the offering organization to the procuring organization. The first collection of information items may be generated internally of the offering organization. The processor may be configured to obtain a second collection of information items relating to the first collection of information items and being generated externally of the offering organization. The processor may also be configured to generate a respective relevance score for each of the second collection of information items relative to a corresponding one of the first collection of information items and generate a respective sentiment score for each of the second collection of information items. The processor may further be configured to generate the probability of the procuring organization accepting the product/service offering based upon the respective relevance scores and respective sentiment scores.

A computer readable medium aspect may be for determining a probability of a procuring organization accepting a product/service offering of an offering organization. The computer readable medium includes computer executable instructions that when executed by a processor cause the processor to perform operations that may include obtaining a first collection of information items relating to the product/service offering from the offering organization to the procuring organization. The first collection of information items may be generated internally of the offering organization. The operations may include obtaining a second collection of information items relating to the first collection of information items and being generated externally of the offering organization and generating a respective relevance score for each of the second collection of information items relative to a corresponding one of the first collection of information items. The operations may further include generating a respective sentiment score for each of the second collection of information items, and generating the probability of the procuring organization accepting the product/service offering based upon the respective relevance scores and respective sentiment scores.

### BRIEF DESCRIPTION OF THE DRAWINGS

FIG. 1 is a schematic block diagram of a system for determining a probability of a procuring organization accepting a product/service offering of an offering organization in accordance with an embodiment.

FIG. 2 is another schematic block diagram of a system for determining a probability of a procuring organization accepting a product/service offering of an offering organization in accordance with an embodiment.

FIG. 3 is a flowchart of operation of a system for determining a probability of a procuring organization accepting a product/service offering of an offering organization in accordance with an embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

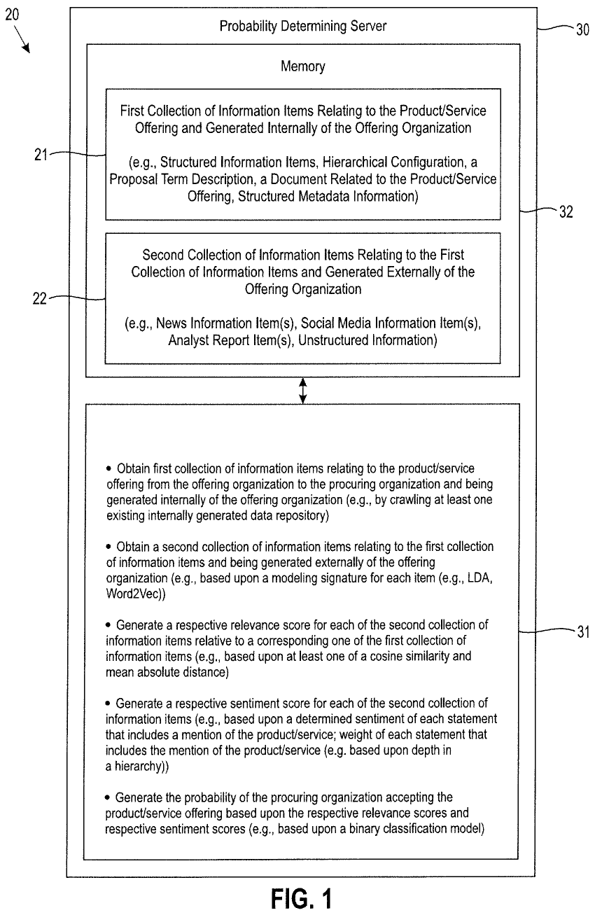

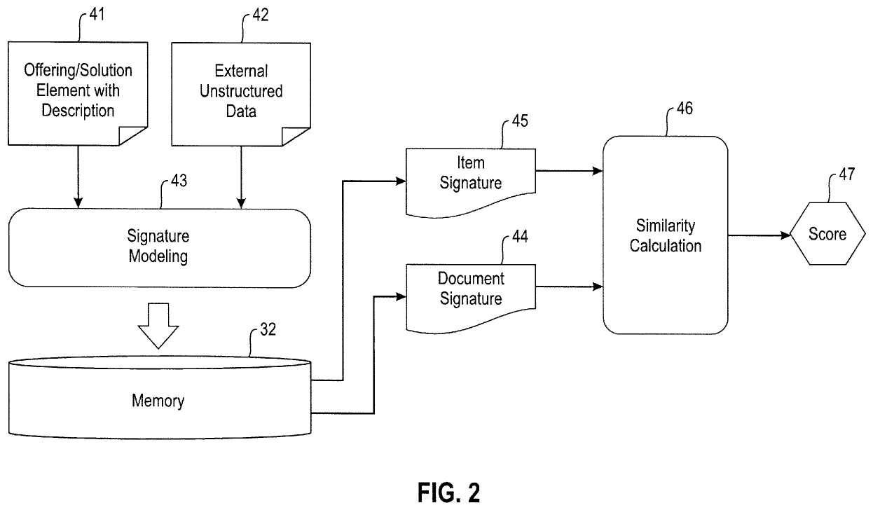

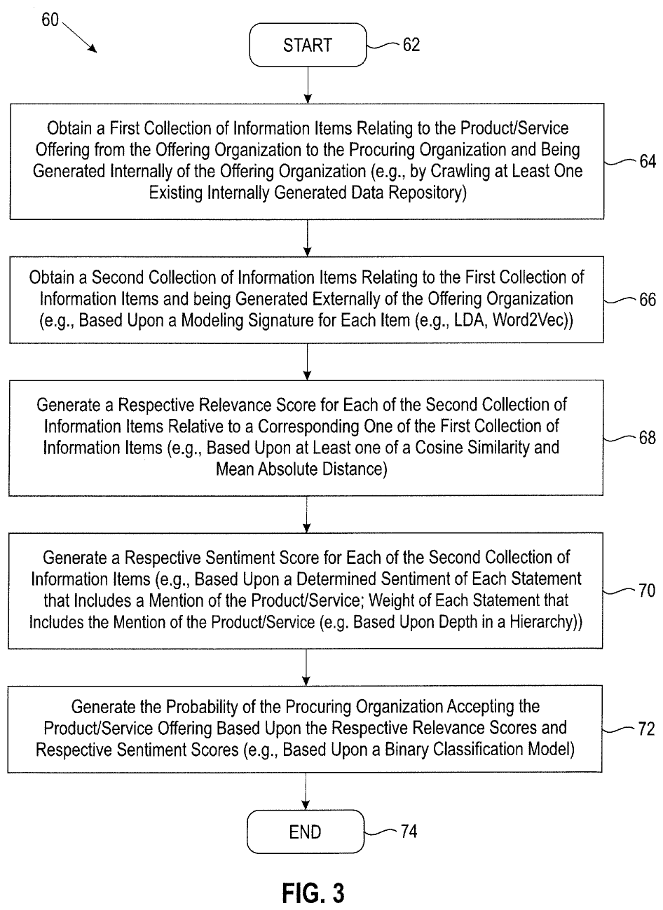

Referring to FIGS. 1 and 2, and the flowchart 60 in FIG. 3, a method of determining a probability of a procuring organization accepting a product/service offering of an offering organization is described. Beginning at Block 62, the method includes using a processor 31 and a memory 32 coupled to the processor to, at Block 64, obtain a first collection of information items 21 relating to the product/service offering from the offering organization to the procuring organization. The processor 31 and memory 32 may be part of probability determining server 30 within a system 20 for determining a probability of a procuring organization accepting a product/service offering of an offering organization, for example. The first collection of information items 21 may be structured information items and generated internally of the offering organization. For example, the first collection of information items 21, which may be stored in the memory 32, may include one or more of a proposal term description, a document related to the product/service offering, structured and/or historical metadata information (e.g., geography, client, competitors, time stamp, etc.), the offerings or deliverables that were delivered as part of that deal, as well as the output of the deal. Those skilled in the art would understand that the term deal generally refers to a contract from a proposal or an accepted product/service offering.

The first collection of information items 21 may also include information items that are structured in a hierarchical configuration. In other words, the first collection of information items 21 may be structured in a hierarchical manner, reflecting the product and organizational structure of a company or offering organization. As will be appreciated by those skilled in the art, the organizational structure of an organization, for example, may affect whether a procuring organization accepts a product/service offering. More particularly, for example, it may be particularly advantageous to know who in an organization is responsible for procurement or acceptance of the product/service offering (e.g., a sales manager v. sales executive).

More particularly, with respect to obtaining the first collection of information items 21 (Block 64), the processor may build a hierarchal representation of the solution elements, considering the company product taxonomy, and the company organization structure. For each solution element, the processor crawls the at least one existing internally generated or existing data repository to obtain the first collection of information items 21 (e.g., related description, documents, and structured metadata information).

At Block 66, the processor 31 obtains, for example, from the Internet, a second collection of information items 22 relating to the first collection of information items. The second collection of information items 22 is being generated externally of the offering organization. The second collection of information items 22 may include at least one of a news information item, a social media information item, and analyst report information item. As will be appreciated by those skilled in the art, external information items may affect whether a product/service is accepted by a procuring organization. The second collection of information items 22 may also include a second collection of unstructured information items. In other words, the processor 31 locates or obtains related externally available unstructured information (e.g., from news, social media, analyst reports, etc.). In an embodiment, the second collection of information items 22 may be obtained based upon a modeling signature for each of the second collection of data items. The second collection of information items 22 may also be stored in the memory 32.

The processor 31 generates a respective relevance score for each of the second collection of information items 22 relative to a corresponding one of the first collection of information items 21 at Block 68. The respective relevance score 47 may be generated based upon at least one of a cosine similarity and a mean absolute distance.

Further details of obtaining the second collection (Block 66) of information items 22 and generating or calculating the respective relevance score 47 (Block 68) will now be described. Signature modeling 43 is performed for each item (offering/solution element 41 and external articles or external unstructured data 42) (FIG. 2) of the second collection of information items 22 with textual descriptions. In one embodiment, a latent dirichlet allocation (LDA) may be used. In particular, the processor 31 may determine latent topic dimension k. Each item is treated as a document represented as a vector representing the probability distribution over topic space. Topic vectors may be learned by maximum-log-likelihood on existing data. In another embodiment, Word2Vec may be used. In particular, the processor 31 treats each item as a document. Each word is represented as a vector (either using existing word2vec result or re-learning one in current data). The item or document signature 44, 45 is obtained by adding its contained words' vectors. In another embodiment, which may be considered a hybrid embodiment, each of the two previous embodiments (e.g., a combination of LDA and Word2Vec) may be used as a basis for the modeling signature.

Signature modeling 43 is performed for items in upper level of hierarchical structure (with no textual description) to obtain item signatures 45 (FIG. 2). In one embodiment, the signature of items is the average of its children in hierarchical tree. In another embodiment, a random-walk-with-restart on the hierarchical structure is performed and the modeling signature is calculated as the weighted sum of all its descendants. A similarity score is calculated 46 with any function: R^{k}×R^{k}→R¹ (FIG. 2). In one embodiment, the similarity score is determined based upon a cosine similarity. In another embodiment, the similarity score is determined based upon a mean absolute distance. Of course, other techniques may be used to determine the similarity score and relevance score 47.

At Block 70, the processor 31 generates a respective sentiment score for each of the second collection of information items 22. Each respective sentiment score may be determined based upon a determined sentiment of each statement that mentions the product/service. With respect to generating a respective sentiment score, for each identified entity in the public data collection or second collection of information items 22, the key matching entities of interest are identified in the provider's product/service (e.g., based on solution elements). More particularly, for each statement document mentioning the provider's product/service, overall sentiment of the document is identified by composing the sentiment of each statement which includes the product/service mention, and amplifying the sentiment score (between −1 to +1) with an increasing weight based on the depth of the product name mentioned in the provider product/service hierarchy. The overall sentiment is aggregated per product/service for all documents mentioning that product/service via a decay function, giving higher priority to more recently authored public data/documents. The sentiment is also aggregated over the whole deal by computing the normalized summary of sentiment over all product/services in the deal, and company itself, to compute an overall sentiment score for each deal (a score between −1 . . . +1).

At Block 72, the processor 31 generates the probability of the procuring organization accepting the product/service offering based upon the respective relevance scores and respective sentiment scores. More particularly, the previous operations or steps (e.g., Blocks 64-70) are applied to the historical deals using the external data with the correct time stamp of these deals. Thus, the sentiment score is obtained for each of these historical deals (Block 70). Any binary classification model may be trained that takes the sentiment score as an input and predicts whether the deal will be won (i.e., accepted) or lost. The features of the training data are the aforementioned scores, and the output is the historical deal output that is known/given. The trained model may then be used on each of the current deals to predict the output score or probability based on the sentiment scores calculated for these deals after applying the operations described above with respect to Blocks 64-70 for these deals. The operations or method ends at Block 74.

As will be appreciated by those skilled in the art, the method described herein of determining the probability of a procuring organization accepting a product/service offering of an offering organization may be particularly advantageous for providing a more accurate indicator of whether a proposal will become a deal or whether the product/service offering will be accepted. In particular, company-level information may be considered a very poor indicator, when used for all in-progress engagements (i.e., products/services) with a given client, due to the relatively diverse set of products and services that are in scope of a product/service. Accordingly the method described herein advantageously uses external information items to determine sentiment that may affect the overall chances of securing a deal or gaining acceptance of a product/service offering.

A system aspect is directed to a system 20 for determining a probability of a procuring organization accepting a product/service offering of an offering organization. The system includes a processor 31 and a memory 32 coupled thereto. The processor 31 is configured to obtain a first collection of information items 21 relating to the product/service offering from the offering organization to the procuring organization. The first collection of information items 21 may be generated internally of the offering organization. The processor 31 is configured to obtain a second collection of information items 22 relating to the first collection of information items 21 and being generated externally of the offering organization. The processor 31 is also configured to generate a respective relevance score 47 for each of the second collection of information items 22 relative to a corresponding one of the first collection of information items 21 and generate a respective sentiment score for each of the second collection of information items. The processor 31 is further configured to generate the probability of the procuring organization accepting the product/service offering based upon the respective relevance scores and respective sentiment scores.

A computer readable medium aspect may be for determining a probability of a procuring organization accepting a product/service offering of an offering organization. The computer readable medium includes computer executable instructions that when executed by a processor 31 cause the processor to perform operations that may include obtaining a first collection of information items 21 relating to the product/service offering from the offering organization to the procuring organization. The first collection of information items 21 may be generated internally of the offering organization. The operations include obtaining a second collection of information items 22 relating to the first collection of information items 21 and being generated externally of the offering organization and generating a respective relevance score 47 for each of the second collection of information items relative to a corresponding one of the first collection of information items. The operations further include generating a respective sentiment score for each of the second collection of information items, and generating the probability of the procuring organization accepting the product/service offering based upon the respective relevance scores and respective sentiment scores.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of determining a probability of a procuring organization accepting a product/service offering of an offering organization, the method comprising:
using a processor and a memory coupled thereto to
obtain a first collection of information items relating to the product/service offering from the offering organization to the procuring organization, the first collection of information items being generated internally of the offering organization,
obtain a second collection of information items relating to the first collection of information items and being generated externally of the offering organization,
generate a respective relevance score for each of the second collection of information items relative to a corresponding one of the first collection of information items,
generate a respective sentiment score for each of the second collection of information items, and
generate the probability of the procuring organization accepting the product/service offering based upon the respective relevance scores and respective sentiment scores.

2. The method of claim 1 wherein the second collection of information items comprises at least one of a news information item, a social media information item, and analyst report information item.

3. The method of claim 1 wherein the second collection of information items comprises a second collection of unstructured information items.

4. The method of claim 1 wherein the first collection of information items comprises at least one of a first collection of structured information items, a proposal term description, a document related to the product/service offering, structured metadata information, and a hierarchically configured first collection of information items.

5. The method of claim 1 wherein using the processor to obtain the first collection of information items comprises using the processor to crawl at least one existing internally generated data repository to obtain the first collection of information items.

6. The method of claim 1 wherein using the processor to generate the respective relevance score comprises using the processor to generate the respective relevance score based upon at least one of a cosine similarity and a mean absolute distance.

7. The method of claim 1 wherein using the processor to obtain the second collection of information items comprises obtaining the second collection of information items based upon a modeling signature for each of the second collection of information items.

8. The method of claim 7 wherein the modeling signature comprises at least one of a latent dirichlet allocation model and a Word2Vec model.

9. The method of claim 1 wherein using the processor to generate the probability of the procuring organization accepting the product/service offering comprises using the processor to generate the probability of the procuring organization accepting the product/service offering based upon a binary classification model.

10. The method of claim 1 wherein using the processor to generate the respective sentiment score for each of the second collection of information items comprises using the processor to generate the respective sentiment score based upon a determined sentiment of each statement that includes a mention of the product/service.

11. The method of claim 10 wherein using the processor to generate the respective sentiment score comprises using the processor to generate the respective sentiment score based upon a determined weight of each statement that includes the mention of the product/service.

12. The method of claim 11 wherein the determined weight is determined based upon a depth of the mention of the product/service in a product/service hierarchy.

13. A system for determining a probability of a procuring organization accepting a product/service offering of an offering organization, the system comprising:
a processor and a memory coupled thereto, the processor configured to
obtain a first collection of information items relating to the product/service offering from the offering organization to the procuring organization, the first collection of information items being generated internally of the offering organization,
obtain a second collection of information items relating to the first collection of information items and being generated externally of the offering organization,
generate a respective relevance score for each of the second collection of information items relative to a corresponding one of the first collection of information items,
generate a respective sentiment score for each of the second collection of information items, and
generate the probability of the procuring organization accepting the product/service offering based upon the respective relevance scores and respective sentiment scores.

14. The system of claim 13 wherein the second collection of information items comprises at least one of a news information item, a social media information item, and analyst report information item.

15. The system of claim 13 wherein the second collection of information items comprises a second collection of unstructured information items.

16. The system of claim 13 wherein the first collection of information items comprises a first collection of structured information items.

17. A computer readable medium for determining a probability of a procuring organization accepting a product/service offering of an offering organization, the computer readable medium comprising computer executable instructions that when executed by a processor cause the processor to perform operations comprising:
obtaining a first collection of information items relating to the product/service offering from the offering organization to the procuring organization, the first collection of information items being generated internally of the offering organization;
obtaining a second collection of information items relating to the first collection of information items and being generated externally of the offering organization;
generating a respective relevance score for each of the second collection of information items relative to a corresponding one of the first collection of information items;
generating a respective sentiment score for each of the second collection of information items; and
generating the probability of the procuring organization accepting the product/service offering based upon the respective relevance scores and respective sentiment scores.

18. The computer readable medium of claim 17 wherein the second collection of information items comprises at least one of a news information item, a social media information item, and analyst report information item.

19. The computer readable medium of claim 17 wherein the second collection of information items comprises a second collection of unstructured information items.

20. The computer readable medium of claim 17 wherein the first collection of information items comprises a first collection of structured information items.
